(19) United States
(12) Patent Application Publication
(10) Pub. No.: US 2010/0013897 A1
(43) Pub. Date: Jan. 21, 2010

(54) INK CARTRIDGE FOR INKJET PRINTERS

(75) Inventors: Daniel Sulser, Wald (CH); Rene Butty, Hinwil (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: PELIKAN HARDCOPY PRODUCTION AG, Egg (CH)

(21) Appl. No.: 12/518,911

(22) PCT Filed: Nov. 12, 2007
(86) PCT No.: PCT/EP07/09777

§ 371 Date: Aug. 19, 2009

(30) Foreign Application Priority Data
Dec. 12, 2006 (DE) 102006058576.3
Jan. 4, 2007 (DE) 102007001084.4
Jul. 30, 2007 (DE) 202007010565.7

(51) Int. Cl. B41J 2/175

(52) U.S. Cl. 347/86

(57) ABSTRACT

Ink cartridge (10) for inkjet printers having a vent hole (17) between ink reservoir (20) and the environment (21), and having a valve (22) associated with an ink outlet (11), which valve is arranged to be brought against the action of a resilient element (6) from a closed position into an open position when the ink cartridge is inserted into the printer, and vice versa. The valve (22) associated with the ink outlet (11) is coupled in such a manner to a valve (23) associated with the vent hole (17) that, when the ink cartridge is inserted into the printer, ink outlet (11) and vent hole (17) are opened in succession, and vice versa when the ink cartridge (10) is removed from the printer.

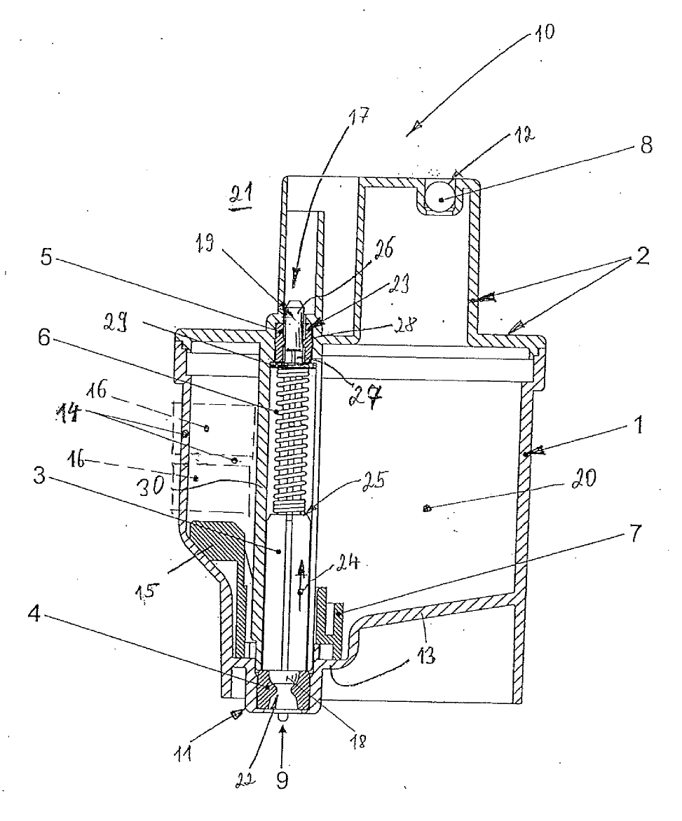

### BACKGROUND

The present invention relates to an ink cartridge for inkjet printers having a vent hole between the ink reservoir and the environment and having a valve associated with an ink outlet, which valve is arranged to be brought against the action of a resilient element from a closed position into an open position when the ink cartridge is inserted into the printer, and vice versa.

The present invention relates also to an ink cartridge of the above-mentioned kind that comprises a fill-level indicator having an opaque or light-reflecting tab, the tab being connected to a float arranged inside the ink cartridge or the housing thereof in such a manner that, as the fill level falls, the said tab is arranged to move either into or, preferably, out of the region of a photoelectric sensor arranged in the printer.

Either prior to or on insertion into the printer, the ink cartridges of the above-mentioned kind, which are sealed for transport, need to be vented by opening a connection between the environment and the interior of the ink cartridge, that is the ink reservoir. In ink cartridges without absorber, that is, in ink cartridges in which no absorbent material, especially no fibrous material or foam material, is present in the ink reservoir, that vent hole should be sealed again when the ink cartridge is removed from the printer so that it is not possible for any residual ink to leak out.

Hitherto, the solution to that problem was as follows:

a) The vent hole is sealed with a so-called “remove label”, that is, a label that is removed manually before the ink cartridge is used for the first time. A disadvantage is that the user sometimes forgets to remove the said label, with the result that the system then does not work.
A further disadvantage is that the vent hole also cannot be sealed again, so that there is a risk of residual ink leaking out when the cartridge is removed from the printer.

The vent hole is sealed by a foil which is punctured on insertion into the printer. A disadvantage in that case, also, is that the vent hole cannot be sealed again, so that here, too, there is the risk of residual ink leaking out of the cartridge when it is removed from the printer.

The vent hole is sealed by means of a valve which is actuated on insertion into the printer and, as a result, opened. When the cartridge is removed from the printer, the valve is closed again.

A factor also common to all of the above solutions is that there is associated with the ink outlet a closure valve, which produces the fluid connection between the cartridge interior or ink reservoir and the printer when the cartridge is inserted into the printer and closes again when the cartridge is removed from the printer. In the last-mentioned solution according to the prior art, two separate valves are thus provided, namely one valve associated with the vent hole and a further valve associated with the ink outlet of the cartridge. The structural expenditure is correspondingly high, both in respect of the cartridge and the printer.

EP 464 502 A1 proposes that the valve associated with the ink outlet and the valve associated with the vent hole be formed in one piece, so that there is a corresponding reduction in terms of structural expenditure. On the other hand, the structural expenditure is substantially increased again in the last-mentioned prior art because the vent hole opens into a valve chamber having a disk valve. The purpose of that valve chamber is to ensure a predetermined reduced pressure in the ink cartridge so that leakage through the ink outlet aperture is reliably avoided under all conditions of use. Generally, however, this problem arises only when the ink cartridge has been mounted above the level of the ink outlet nozzles of the print head, thus, for example, on a print head that is arranged to move to and fro.

### SUMMARY

The object of the present invention is to provide ink cartridges of the kind mentioned at the outset that are available especially for stationary assembly in the printer and that are appreciably safer to handle and consequently more user friendly compared with known ink cartridges for that particular use, the intention being for those advantages to be achieved with minimum structural expenditure.

A further object of the present invention is to provide an ink cartridge of the kind mentioned at the outset that includes a simple and operationally reliable ink-level indicator.

The above-mentioned objects are achieved in accordance with the invention with advantageous structural developments and embodiments being described below.

As regards an arrangement according to the invention, reference is also provided herein.

With the construction according to the invention, therefore, the venting of the ink reservoir is coupled structurally to the opening of the ink outlet, and preferably in such a manner that the valve body associated with the vent hole is connected to the valve body associated with the ink outlet by a rod-like connecting element or a tappet. That connection and the valve bodies or corresponding valves are so aligned with one another therein that, when the cartridge is inserted into the printer, first the ink outlet is opened and then the vent hole. When the ink cartridge is removed, sealing of the cartridge occurs in the reverse order, that is to say, first of all the vent hole is closed and then the ink outlet. An operationally reliable ink cartridge, which on handling does not result in soiling of the environment or, in particular, of the user, is thus provided by simple means. The user has no need to consider whether the vent hole is open or closed, since it is opened or closed automatically as a function of the actuation of the valve associated with the ink outlet.

With respect to the also-mentioned ink-level indicator inside the cartridge, it may in addition be mentioned that the tab to which reference has already been made is connected to a float that is arranged to move along a guide which extends approximately perpendicularly to the base wall of the ink cartridge or of the housing thereof. Preferably, the float is of ring-like construction and extends inside the cartridge or the housing thereof about a rod-like or sleeve-like guide. To avoid tilting of the float and tab, the float is preferably of sleeve-like construction. The float naturally consists of a material having a density that is slightly lower than the density of the ink. A corresponding plastics material is preferably used for the float.

The ink cartridge generally comprises a base, four walls and a lid, the tab connected to the float being arranged to move, following the fill level, from a top position which is close to the lid into a bottom position which is close to the base, inside a tongue- and slot-like wall region formed in a wall, especially a narrow front wall, and extending perpendicularly to the base of the ink cartridge. At least in the region of that tongue- and slot-like wall region, since that wall region protrudes into the already-mentioned photoelectric sensor of the printer or of the ink cartridge receptacle of the printer the ink cartridge consists of a transparent or translucent material, especially plastics, so that the photoelectric sensor is able to co-operate in a manner known per se with the tab connected to the float.

### BRIEF DESCRIPTION OF THE DRAWINGS

A preferred embodiment of an ink cartridge constructed in accordance with the invention is described in detail in the following with reference to the accompanying drawing, which shows a longitudinal section of the ink cartridge.

### DETAILED DESCRIPTION OF THE PREFERRED EMBODIMENTS

The attached drawing thus shows an ink cartridge 10 for an inkjet printer, not shown, having a vent hole 17 between ink reservoir 20 and the environment 21, and having a valve 22 associated with an ink outlet 11 in the base 13 of the housing 1 of the ink cartridge 10, which valve is arranged to be brought against the action of a resilient element, here a helical pressure spring 6, from a closed position shown in the attached drawing into an open position when the ink cartridge is inserted into the printer, and vice versa. According to the invention, the valve 22 associated with the ink outlet 11 is coupled in such a manner to a valve 23 associated with the vent hole 17 that, when the ink cartridge is inserted into the printer, ink outlet 11 and vent hole 17 are opened, and vice versa when the ink cartridge is removed from the printer. The said coupling is so arranged that, when the ink cartridge is inserted into the printer, first the ink outlet 11 is opened and then the vent hole 17, and vice versa when the ink cartridge is removed from the printer.

The valve 22 associated with the ink outlet 11 has a first valve body 18 co-operating with a connection seal 4 arranged in the ink outlet 11, while the valve 23 associated with the vent hole 17 has a second valve body 19 co-operating with an inlet seal 5 arranged in the vent hole 17, the two valve bodies 18 and 19 being rigidly connected to one another, namely by a rod-like connecting element in the form of a tappet 3. There is active in the region between the valve body 18 associated with the ink outlet 11 and a wall lying opposite to the valve body 18, namely the lid 2 of the ink cartridge 10 or of the housing 1 thereof, a resilient element, namely a helical pressure spring 6, against the action of which the valve body 18 is arranged to be brought or pushed from its closed position into the open position, according to arrow 24. The helical pressure spring 6 is supported on the one hand against a shoulder 25 of the tappet 3 between the two valve bodies 18 and 19, and on the other hand against the wall delimiting the vent hole 17, namely the lid wall of the ink cartridge or of the housing thereof.

The rod-like connecting element, that is the tappet 3, may have a cross-section having a circular, rectangular or cross-shaped profile. In the embodiment in the accompanying drawing, the last-mentioned cross-section is used.

The valve body 19 associated with the vent hole 17 comprises, on the one hand, an outer cylindrical piston portion 26 and, on the other hand, an inner venting portion 27, that is, a venting portion associated with the ink reservoir 20, the venting portion moving into the operative position, that is, venting position, only after the valve 22 associated with the ink outlet 11 has opened. The venting portion 27 is formed as a continuation of the piston portion 26, that is, has the same external diameter as the piston portion 26. However it has at least one portion of reduced cross-section extending over its length in order to render possible venting of the ink reservoir 20 after a corresponding movement of the piston portion 26 out of the inlet seal 5. In the embodiment shown, the venting portion 27 has a cross-section having a cross-shaped profile that also extends into the region of the helical pressure spring 6.

This ensures that the inlet seal is not applied in air-tight manner around the venting portion 27 when the piston portion 26 of the second valve body 19 has been moved out of the inlet seal 5 or out of the region of a ring-like sealing bead 28 thereof. It also ensures that the valve body 19 can be moved smoothly past the ring-like sealing bead 28 of the inlet seal 5 and also in the transition region between piston portion 26 and venting portion 27.

It may also be mentioned that a supporting ring 29 of metal or plastics is arranged between the lid wall and the helical pressure spring 6 in order to support the helical pressure spring 9 against the lid wall delimiting the vent hole 17. The supporting ring also secures the inlet seal 5 inside the vent hole 17 and prevents the inlet seal 5 from creeping into the housing interior or into the ink reservoir 20.

The ink cartridge 10 is furthermore filled by way of an ink filling aperture 12 arranged in the lid 2, the aperture being sealed in fluid-tight manner by a sealing plug 8 after the cartridge has been filled.

It may also be mentioned that the first valve body 18 defines a spherical zone. The sealing seat of the connection seal 4 is constructed so as to be complementary thereto.

Finally, at the bottom free end of the valve body 18 there is, in addition, a protrusion 9 in the form of a protruding pin which, when the ink cartridge 10 is placed on a flat support, e.g. a table, keeps the outlet aperture 11 spaced therefrom and prevents or at least reduces any spillage onto the support.

The described ink cartridge is especially for stationary assembly in a printer, in which case it is so positioned that the ink level always lies below the print-head ink outlet nozzles which are arranged to be fluid-connected to it. Unintentional leakage of ink through the print head nozzles brought about by the direct connection of the ink receptacle of the ink cartridge to the outside atmosphere after the ink cartridge has been inserted in the printer is thereby reliably avoided.

In principle, the ink cartridges according to the invention are also suitable for assembly on a print head that is arranged to move to and fro; in that case, also, it is merely necessary to ensure that the assembly is such that the ink level in the cartridge always lies below the ink outlet apertures of the print head.

The illustrated embodiment of an ink cartridge in addition has a fill-level indicator comprising an opaque or alternatively light-reflecting tab 15, the tab 15 being so connected to a float 7 arranged inside the ink cartridge 10 or the housing 1 thereof that, as the fill level drops, the tab is arranged to move either into or, as is the case here, out of the region of a photoelectric sensor 16 arranged in the printer. The float 7 is arranged to move along a guide 30, which extends perpendicularly to the base wall 13 of the ink cartridge 10 or of the housing 1 thereof and around the ink outlet 11. For that purpose, the float 7 is of sleeve-like construction. It extends inside the cartridge or the housing thereof about a rod-like guide or, as in this case, a likewise sleeve-like guide 30. Inside that sleeve-like guide 30 the tappet 3, which connects to one another the two valve bodies 18 and 19, is mounted so as to be longitudinally displaceable under the pre-biasing of the helical pressure spring 6.

In the embodiment shown, the sleeve-like guide 30 is connected in one piece to the lid 2 of the ink cartridge 10. It extends between ink outlet 11 and the vent hole 17 arranged opposite thereto.

Also of special importance is the fact that the tab 15 connected to the float 7 is arranged to move, following the fill level, from a top position which is close to the lid into a bottom position which is close to the base, inside a tongue- and slot-like wall region 14 formed in a narrow front wall and extending perpendicularly to the base 13 of the ink cartridge 10 or of the housing thereof. In the embodiment shown, the tab 15 is already located in the lowest position, in which the ink cartridge is empty. At least the tongue- and slot-like wall region 14 consists of transparent or translucent material, especially plastics, so that co-operation between the photoelectric sensor 16 on the one hand and the tab 15 on the other hand is ensured in that region. The photoelectric sensor 16 is preferably divided into segments in order to display the actual fill level of the cartridge, especially to display in good time when the ink is running out. Ultimately, however, these are details specific to the printer and are not the concern of the present invention. The reference to the photoelectric sensor 16 serves in the present case merely to explain the function of the tab 15.

As has already been mentioned at the outset, the float 7 consists of material having a density that is at least slightly lower than the density of the ink in the ink reservoir 20 of the cartridge 10. Tab 15 and float 7 consist of the same material and are preferably produced in one piece. The float 7 together with the tab 15 are pushed onto the vertical guide 30 before the lid 2 is mounted. In addition, the inlet seal 5, the supporting ring 29, the helical pressure spring 6 and the tappet 3, together with the valve bodies 18, 19 connected to the tappet 3, are inserted into the vertical guide 30 before the lid 2 is mounted. The lid 2 is then mounted relative to the ink outlet 11 and the connection seal 4 arranged therein.

With respect to the supporting ring 29 to which reference has already been made, it may in addition be mentioned that this ensures that the inlet seal 5 is not acted upon directly by the helical pressure spring 6 and deformed.

It may also be mentioned that the float and tab 15 consist of a material having a density ρ of approximately 0.9 g/cm³.

In respect of the tongue- and slot-like wall region 14 it may in addition be mentioned that this appears from the outside like a protruding tongue. From the inside of the housing, that tongue defines a vertical slot inside which the float tab 15 is able to move up and down.

All features disclosed in the application documents are claimed as important to the invention insofar as they are novel, individually or in combination, compared with the prior art.

### REFERENCE NUMERALS

1 housing
2 lid
3 rod-like connecting element (tappet)
4 connection seal
5 inlet seal
6 pressure spring
7 float
8 sealing plug
9 protrusion
10 ink cartridge
11 ink outlet
12 ink filling aperture
13 base
14 tongue- and slot-like wall region
15 tab
16 photoelectric sensor
17 vent hole
18 first valve body
19 second valve body
20 ink reservoir
21 environment
22 valve
23 valve
24 arrow
25 shoulder
26 piston portion
27 venting portion
28 ring-like sealing bead
29 supporting ring
30 vertical guide

1. Ink cartridge (10) for mounting below a level of ink outlet nozzles of an associated print head of an inkjet printer, comprising a vent hole (17) for an ink reservoir (20) and having a valve (22) associated with an ink outlet (11), the valve is arranged to be brought against the action of a resilient element (6) from a closed position into an open position when the ink cartridge is inserted into the printer, and vice versa, wherein the valve (22) associated with the ink outlet (11) is coupled in such a manner to a valve (23) associated with the vent hole (17) that, when the ink cartridge is inserted into the printer, the ink outlet (11) and the vent hole (17) are opened in succession, and vice versa when the ink cartridge (10) is removed from the printer, and the vent hole (17) leads directly to an outside environment so that, when the ink cartridge (10) is in use, the ink reservoir (20) is in direct connection with atmospheric pressure by way of the vent hole (17).

2. Ink cartridge according to claim 1, wherein the valves are configured such that on insertion into the printer, first the ink outlet (11) is opened and then the vent hole (17), and vice versa when the ink cartridge (10) is removed from the printer.

3. Ink cartridge according to claim 1, wherein the valve (22) associated with the ink outlet (11) has a first valve body (18) co-operating with a seal (4) arranged in the ink outlet (11), and the valve (23) associated with the vent hole (17) has a second valve body (19) co-operating with a seal (5) arranged in the vent hole (17), and the two valve bodies (18, 19) are rigidly connected to one another.

4. Ink cartridge according to claim 1, wherein there is active, in a region between the valve body (18) associated with the ink outlet (11) and a wall (2) lying opposite thereto of the ink cartridge (10) or of the housing thereof, a resilient element, against the action of which the valve body (18) for the ink outlet (11) is arranged to be brought from a closed position into the open position.

5. Ink cartridge according to claim 3, wherein the resilient element is supported on the one hand against a shoulder (25) of a connecting element (3) between the two valve bodies (18, 19), and on the other hand against the wall (2) of the ink cartridge (10) delimiting the vent hole (17).

6. Ink cartridge according to claim 5, wherein the connecting element (3) is rod-shaped and has a cross-section having a circular, rectangular, triangular or cross-shaped profile.

7. Ink cartridge according to claim 3, wherein the second valve body (19) associated with the vent hole (17) comprises an outer cylindrical piston portion (26) and, an inner venting portion (27) facing the ink reservoir (20), the venting portion moving into an operative position, that is, venting position, only after the valve (22) associated with the ink outlet (11) has opened.

8. Ink cartridge according to claim 7, wherein the inner venting portion (27) is formed as a continuation of the outer cylindrical piston portion (26) but has at least one portion of reduced cross-section extending over its length.

9. Ink cartridge, especially according to claim 1, further comprising a fill-level indicator comprising an opaque or light-reflecting tab (15), the tab (15) being so connected to a float (7) arranged inside the ink cartridge (10) or a housing (1) thereof that, as a fill level drops, the tab is arranged to move either into or out of a region of a photoelectric sensor (16) arranged in the printer, the float (7) is arranged to move along a guide (30), which extends approximately perpendicularly to a base wall (13) of the ink cartridge (10) or of the housing (1) thereof.

10. Ink cartridge according to claim 9, wherein the float (7) has a ring-like construction and extends inside the cartridge (10) or the housing (1) thereof about the guide element (30) which is rod or sleeve-shaped.

11. Ink cartridge according to claim 6, wherein the rod-shaped connecting element (3) between the two valve bodies (18, 19) extends within, and is mounted so as to be longitudinally displaceable within, a sleeve-like guide element (30) for a float (7) arranged inside the ink cartridge (10) or a housing (1) thereof.

12. Ink cartridge according to claim 10, wherein the guide element (30) is connected in one piece with the base wall (13) or lid (2) of the ink cartridge (10).

13. Ink cartridge according to claim 9, wherein the guide element (30) for the float (7) extends between the ink outlet (11) and the vent hole (17).

14. Ink cartridge according to claim 1, further comprising a housing (1) which comprises a base (13) and walls, and a lid (2), the ink outlet (11) is formed in the base (13), and the vent hole (17) is formed in the lid (2) opposite to the ink outlet (11).

15. Ink cartridge according to claim 9, wherein the tab (15) connected to the float (7) is arranged to move, following the fill level, from a top position which is close to a lid into a bottom position which is close to a base of a housing for the ink cartridge (10), inside a tongue- and slot-like wall region (14) formed in a wall and extending approximately perpendicularly to the base (13) of the ink cartridge (10) or of the housing (1) thereof.

16. Ink cartridge according to claim 15, wherein at least the tongue- and slot-like wall region (14) consists of transparent or translucent material.

17. Ink cartridge (10) according to claim 1, wherein the ink cartridge (10) is adapted to be located in an inkjet printer such that a level of the ink in the cartridge (10) always lies below a level of the ink outlet apertures of the associated print head.

18. Ink Cartridge (10) according to claim 17, wherein the ink cartridge (10) is adapted to be mounted in stationary manner in the printer.
